(19) United States
(12) Patent Application Publication
(10) Pub. No.: US 2023/0237071 A1
(43) Pub. Date: Jul. 27, 2023

(54) METHOD AND SYSTEM FOR BIG DATA ANALYSIS

(71) Applicant: Qingdao Zhenyou Software Technology Co., Ltd., Qingdao (CN)

(72) Inventor: Kefeng Zhu, Guangzhou (CN)

(73) Assignee: Qingdao Zhenyou Software Technology Co., Ltd., Qingdao (CN)

(21) Appl. No.: 17/688,928

(22) Filed: Mar. 8, 2022

(30) Foreign Application Priority Data
Jan. 27, 2022 (CN) 202210099328.8

(51) Int. Cl. G06F 16/28; G06F 16/2453

(52) U.S. Cl. CPC G06F 16/283; G06F 16/24532

(57) ABSTRACT

A method includes: obtaining a multi-type service data report that requires data analysis; analyzing and processing the multi-type service data report to determine N types of service data that fluctuate in the multi-type service data report, where N is an integer greater than or equal to 1; and screening out abnormal service data that abnormally fluctuates from the N types of service data and exporting the abnormal service data. A system for big data analysis is further provided. Instead of simply regarding fluctuant service data as abnormal service data, the method and the system determine abnormal service data based on the N types of fluctuant service data in the multi-type service data report. This reduces overreactions and helps reasonably measure service data. Therefore, service data can be thoroughly analyzed.

### CROSS REFERENCE TO THE RELATED APPLICATIONS

This application is based upon and claims priority to Chinese Patent Application No. 202210099328.8, filed on Jan. 27, 2022, the entire contents of which are incorporated herein by reference.

### TECHNICAL FIELD

The present invention relates to the field of data analysis, and more particularly, to a method and system for big data analysis.

### BACKGROUND

At present, a data analysis result obtained by using a data analysis application shows only a data fluctuation curve, but does not indicate whether data fluctuates within a normal range. As a result, data cannot be thoroughly analyzed.

### SUMMARY

The present invention provides a method and system for big data analysis to help thoroughly analyze multi-type service data.

According to a first aspect, an embodiment of the present invention provides a method for big data analysis, including:

obtaining a multi-type service data report that requires data analysis;

analyzing and processing the multi-type service data report to determine N types of service data that fluctuate in the multi-type service data report, where N is an integer greater than or equal to 1; and

screening out abnormal service data that abnormally fluctuates from the N types of service data and exporting the abnormal service data.

Instead of simply regarding fluctuant service data as abnormal service data, this embodiment of the present invention determines abnormal service data based on the N types of fluctuant service data in the multi-type service data report. This reduces overreactions and helps reasonably measure service data. Therefore, service data can be thoroughly analyzed.

In a possible design, the step of obtaining the multi-type service data report that requires the data analysis includes:

collecting multi-type service data to obtain multi-type service datasets;

obtaining a preset analysis type and a preset analysis indicator corresponding to the preset analysis type; and

performing statistical analysis on the multi-type service datasets based on the preset analysis type and the preset analysis indicator to obtain the multi-type service data report.

This embodiment of the present invention uses a preset analysis type and a preset analysis indicator corresponding to the preset analysis type to perform statistical analysis on multi-type service datasets. In contrast to a manual method used to obtain multi-type service data in the prior art, this method can quickly generate funnel analysis data. This facilitates thorough analysis of multi-type service data and helps quickly identify the service data that abnormally fluctuates.

In a possible design, the step of collecting the multi-type service data to obtain the multi-type service datasets includes:

obtaining a preset analysis type dimension; and

collecting the multi-type service data based on the analysis type dimension to obtain the multi-type service datasets.

This embodiment of the present invention collects multi-type service data based on the preset analysis type dimension. This helps collect multi-type service data corresponding to different analysis type dimensions and facilitates thorough analysis of multi-type service data.

In a possible design, if the preset analysis type is the number of daily active users (DAU), the preset analysis indicator includes one or more of an advertisement channel, country, and registration date; or if the preset analysis type is player behavior, the preset analysis indicator includes one or more of player construction behavior, player production behavior, and alliance helping behavior.

In a possible design, the step of analyzing and processing the multi-type service data report to determine the N types of service data that fluctuate in the multi-type service data report includes:

analyzing and processing the multi-type service data report by using a process behavior chart (PBC) core algorithm to obtain a PBC report corresponding to the multi-type service data; and

determining, based on the PBC report, the N types of service data that fluctuate in the multi-type service data report.

This embodiment of the present invention uses a PBC report to manage and analyze data. This can screen out a fluctuation noise in the analysis indicator, better reflect a fluctuation in the analysis indicator, and accurately identify a data signal (e.g., service data).

In a possible design, the step of determining, based on the PBC report, the N types of service data that fluctuate in the multi-type service data report includes:

obtaining a preset initial baseline, where the initial baseline includes a first upper threshold, a first lower threshold, and a first average line; and

if it is determined, based on the initial baseline and the PBC report, that Y types of service data having M consecutive first data signals lower or greater than the first average line exist in the multi-type service data report, adjusting the initial baseline to a first baseline at the M first data signals, where the first baseline includes a second upper threshold, a second lower threshold, and a second average line;

if it is determined that X types of service data having M consecutive second data signals lower or greater than the second average line exist in the Y types of service data, adjusting the first baseline to a second baseline at the M second data signals, where the second baseline includes a third upper threshold, a third lower threshold, and a third average line; replacing the initial baseline with the first baseline, the first baseline with the second baseline, and the Y types of service data with the X types of service data, and repeating the following step: if it is determined, based on the initial baseline and the PBC report, that Y types of service data having M consecutive first data signals lower or greater than the first average line exist in the multi-type service data report, adjusting the initial baseline to the first baseline at the M first data signals; or

if it is determined that the X types of service data do not exist in the Y types of service data, determining the Y types of service data as the N types of service data.

Instead of simply regarding fluctuant service data as abnormal service data, this embodiment of the present invention uses a PBC report to manage and analyze data and determines the service data that abnormally fluctuates in the fluctuant service data as abnormal service data. This reduces overreactions and helps reasonably measure service data. Therefore, service data can be thoroughly analyzed.

In a possible design, the method further includes:

if it is determined, based on the initial baseline and the PBC report, that the Y types of service data do not exist in the multi-type service data report, determining service data having a data signal lower than the first lower threshold or greater than the first upper threshold in the multi-type service data report as the N types of service data.

In a possible design, the step of screening out the abnormal service data that abnormally fluctuates from the N types of service data and exporting the abnormal service data includes:

if it is determined that the Y types of service data do not exist in the multi-type service data report, determining service data greater than the first upper threshold or lower than the first lower threshold in the N types of service data as the abnormal service data; or if it is determined that the X types of service data do not exist in the Y types of service data, determining service data greater than the second upper threshold or lower than the second lower threshold in the Y types of service data as the abnormal service data; and

visually exporting the abnormal service data.

Instead of simply regarding fluctuant service data as abnormal service data, this embodiment of the present invention uses a PBC report to manage and analyze data and determines the service data that abnormally fluctuates in the fluctuant service data as abnormal service data. This reduces overreactions and helps reasonably measure service data. Therefore, service data can be thoroughly analyzed. In addition, abnormal service data is visually exported. This helps a user visually identify abnormal service data and take corresponding measures.

In a possible design, after the multi-type service data report that requires data analysis is obtained, the method further includes:

obtaining a query request for the multi-type service data; and

parallelly querying the multi-type service data based on the query request.

Compared with the query of multi-type service data in a serial mode in the prior art, this embodiment of the present invention allows parallel query of multi-type service data. This improves data query efficiency and data query performance. In addition, the multi-type service data report includes information such as an analysis type dimension, analysis type, and analysis indicator. After a data analysis system queries the multi-type service data, the information corresponding to the multi-type service data can be reflected in the query result.

According to a second aspect, an embodiment of the present invention further provides a data analysis system, including:

a processing unit, configured to: obtain a multi-type service data report that requires data analysis, and analyze and process the multi-type service data report to determine N types of service data that fluctuate in the multi-type service data report, where N is an integer greater than or equal to 1; and

an export unit, configured to: screen out abnormal service data that abnormally fluctuates from the N types of service data and export the abnormal service data.

In a possible design, the processing unit is specifically configured to:

collect multi-type service data to obtain multi-type service datasets;

obtain a preset analysis type and a preset analysis indicator corresponding to the preset analysis type; and

perform statistical analysis on the multi-type service datasets based on the preset analysis type and the preset analysis indicator to obtain the multi-type service data report.

In a possible design, the processing unit is specifically configured to:

obtain a preset analysis type dimension; and

collect the multi-type service data based on the analysis type dimension to obtain the multi-type service datasets.

In a possible design, if the preset analysis type is the number of DAUs, the preset analysis indicator includes one or more of an advertisement channel, country, and registration date; or if the preset analysis type is player behavior, the preset analysis indicator includes one or more of player construction behavior, player production behavior, and alliance helping behavior.

In a possible design, the processing unit is specifically configured to:

analyze and process the multi-type service data report by using a PBC core algorithm to obtain a PBC report corresponding to the multi-type service data; and

determine, based on the PBC report, the N types of service data that fluctuate in the multi-type service data report.

In a possible design, the processing unit is specifically configured to:

obtain a preset initial baseline, where the initial baseline includes a first upper threshold, a first lower threshold, and a first average line; and

if it is determined, based on the initial baseline and the PBC report, that Y types of service data having M consecutive first data signals lower or greater than the first average line exist in the multi-type service data report, adjust the initial baseline to a first baseline at the M first data signals, where the first baseline includes a second upper threshold, a second lower threshold, and a second average line;

if it is determined that X types of service data having M consecutive second data signals lower or greater than the second average line exist in the Y types of service data, adjust the first baseline to a second baseline at the M second data signals, where the second baseline includes a third upper threshold, a third lower threshold, and a third average line; replace the initial baseline with the first baseline, the first baseline with the second baseline, and the Y types of service data with the X types of service data, and repeat the following step: if it is determined, based on the initial baseline and the PBC report, that Y types of service data having M consecutive first data signals lower or greater than the first average line exist in the multi-type service data report, adjust the initial baseline to the first baseline at the M first data signals; or

if it is determined that the X types of service data do not exist in the Y types of service data, determine the Y types of service data as the N types of service data.

In a possible design, the processing unit is further configured to:

if it is determined, based on the initial baseline and the PBC report, that the Y types of service data do not exist in the multi-type service data report, determine service data having a data signal lower than the first lower threshold or greater than the first upper threshold in the multi-type service data report as the N types of service data.

In a possible design, the export unit is specifically configured to:

if it is determined that the Y types of service data do not exist in the multi-type service data report, determine service data greater than the first upper threshold or lower than the first lower threshold in the N types of service data as the abnormal service data; or if it is determined that the X types of service data do not exist in the Y types of service data, determine service data greater than the second upper threshold or lower than the second lower threshold in the Y types of service data as the abnormal service data; and

visually export the abnormal service data.

In a possible design, the processing unit is further configured to:

obtain a query request for the multi-type service data; and

parallelly query the multi-type service data based on the query request.

According to a third aspect, an embodiment of the present invention provides a data analysis device that includes at least one memory and at least one processor, where

the memory is configured to store one or more programs; and

when the one or more programs are executed by the at least one processor, the method in any of the possible designs in the first aspect is implemented.

According to a fourth aspect, an embodiment of the present invention further provides a computer readable storage medium that stores at least one program, and when the at least one program is executed by the processor, the method in any of the possible designs in the first aspect is implemented.

The technical benefits of the second, third, or fourth aspect are similar to those of the first aspect. Details are not repeated.

For a better understanding and implementation, the present invention will be described in detail below with reference to the accompanying drawings.

### BRIEF DESCRIPTION OF THE DRAWINGS

FIG. 1 is a schematic flowchart of a method for big data analysis according to an embodiment of the present invention;

FIG. 2 is a schematic diagram of a multi-type service data report according to an embodiment of the present invention;

FIG. 3 is a schematic diagram of a PBC report according to an embodiment of the present invention;

FIG. 4 is another schematic flowchart of a method for big data analysis according to an embodiment of the present invention;

FIG. 5 is a schematic diagram of an architecture of a data analysis system according to an embodiment of the present invention; and

FIG. 6 is a schematic diagram of a structure of a data analysis device according to an embodiment of the present invention.

### DETAILED DESCRIPTION OF THE EMBODIMENTS

The implementations described in the following exemplary embodiments do not represent all implementations consistent with the present invention. On the contrary, they are merely embodiments consistent with some aspects of the present invention.

The terms used in the present invention are merely to describe the specific embodiments, instead of limiting the present invention. The singular forms “one”, “the”, and “this” used in the present invention are also intended to cover plural forms unless their meanings are clarified in the context. It should also be understood that the term “and/or” used herein refers to and includes any of one or more of the associated listed items or all possible combinations.

It should be noted that the terms “first”, “second”, and the like in the embodiments of the present invention are intended to distinguish between objects but not limit the order, time sequence, priority, or importance of these objects unless otherwise is stated.

The method for big data analysis provided in the embodiments of the present invention can be used for data analysis in the business intelligence (BI) field and other fields, which is not limited in the embodiments of the present invention.

The following describes the technical solutions in the embodiments of the present invention with reference to the accompanying drawings of the present invention.

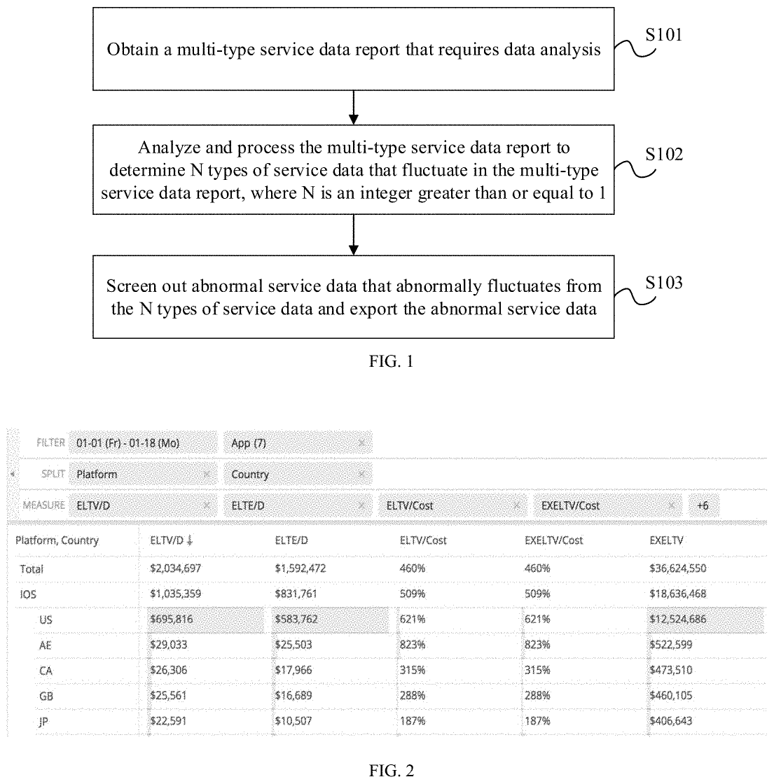

FIG. 1 shows a method for big data analysis according to an embodiment of the present invention. The method may include the following steps:

S101: Obtain a multi-type service data report that requires data analysis.

In some embodiments, a data analysis system can collect multi-type service data to obtain multi-type service datasets. In other words, the data analysis system collects service data for each service type and organizes the service data as a service dataset for the service type.

In specific implementation, the data analysis system can obtain a preset analysis type dimension and collects multi-type service data based on the preset analysis type dimension so as to obtain multi-type service datasets.

For example, the data analysis system can use a data migration tool, such as Apache Sqoop or DataX, to collect multi-type service data from a service database based on the preset analysis type dimension, and/or use a log collection system, such as Apache Flume, to collect multi-type service data from various log servers based on the preset analysis type dimension. An example of the preset analysis type dimension is time. In this case, the data analysis system can use a data migration tool, such as Apache Sqoop or DataX, to collect multi-type service data from a service database (such as a service database of a player) by the dimension of time, and/or use a log collection system to collect multi-type service data from various log servers by time.

For example, after obtaining the multi-type service datasets, the data analysis system can store the multi-type service data that is collected by using the data migration tool, such as Apache Sqoop or DataX, to the operational data store (ODS) layer of a data warehouse tool, such as Apache Hive. In addition, the data analysis system can store the multi-type service data—collected from various log servers by using the log collection system, such as Apache Flume—to a Hadoop distributed file system (HDFS). For example, the data analysis system can use a Kafka system to store the multi-type service data that is collected from various log servers by using the log collection system (such as Apache Flume) to the HDFS, where the Kafka system is a distributed publish-subscribe messaging system with high throughput.

In specific implementation, the preset analysis type dimension may include but is not limited to one or more of the following dimensions: time, application, computer platform, language, channel, advertisement channel catalog, and country.

This embodiment of the present invention collects multi-type service data based on the preset analysis type dimension. This helps collect multi-type service data corresponding to different analysis type dimensions and facilitates thorough analysis of multi-type service data.

In some embodiments, the data analysis system can obtain a preset analysis type and a preset analysis indicator corresponding to the preset analysis type after obtaining the multi-type service datasets. The preset analysis type and the preset analysis indicator can be stored in the data analysis system in advance or obtained from another device (such as a server that stores multi-type service data). This is not limited in the embodiments of the present invention.

For example, the preset analysis type may include but is not limited to the number of DAUs or player behavior. The preset analysis indicator may include but is not limited to the number of installations (activations), number of installations per day (activations/D), employee lifetime value (ELTV), ratio of ELTV to costs (ELTV/cost), retention rate, advertisement channel, country, registration date, player construction behavior, play production behavior, alliance helping behavior, or player purchasing behavior.

For example, if the preset analysis type is the number of DAUs, the preset analysis indicator may include but is not limited to one or more of the advertisement channel, country, and registration date. Alternatively, if the preset analysis type is player behavior, the preset analysis indicator may include but is not limited to one or more of player construction behavior, player production behavior, and alliance helping behavior.

In some embodiments, the data analysis system can perform statistical analysis on the multi-type service datasets based on the preset analysis type and the preset analysis indicator to obtain the multi-type service data report. For example, the preset analysis type is the number of DAUs. In this case, the data analysis system can use one or more of the following analysis indicators in web logs (weblogETL) to collect statistics on the number of DAUs and obtain the multi-type service data report: advertisement channel, country, and registration data. Alternatively, the preset analysis type is player behavior. In this case, the data analysis system can use one or more of the following analysis indicators in server logs (serverlog) to collect statistics on player purchasing behavior and obtain the multi-type service data report: player construction behavior, player production behavior, and alliance helping behavior.

FIG. 2 provides an example on a service data report that may include multiple types of service data. This enriches display formats of numbers and can facilitate data analysis performed by a data analysis system or a service analyst.

This embodiment of the present invention uses a preset analysis type and a preset analysis indicator corresponding to the preset analysis type to perform statistical analysis on multi-type service datasets. In contrast to a manual method used to obtain multi-type service data in the prior art, this method can quickly generate funnel analysis data. This facilitates thorough analysis of service data and helps quickly identify the service data that abnormally fluctuates.

S102: Analyze and process the multi-type service data report to determine N types of service data that fluctuate in the multi-type service data report, where N is an integer greater than or equal to 1.

In some embodiments, the data analysis system can obtain operational information that includes information about a report display format before analyzing and processing the multi-type service data report. The data analysis system can determine the report display format of the multi-type service data report based on the operational information. The report display format may include but is not limited to a PBC report, a period report, a like PBC chart (LPC) report, a summary report, an overview report, a linear chart, a bar chart, or a heat map. In the following, the report display format of the multi-type service data report is the PBC report.

For example, the data analysis system can provide an interface for selecting a report display format. The interface provides controls corresponding to various report display formats for a corresponding service expert to use. If a user triggers or clicks a specific report display format, operational information is generated and can be obtained by the data analysis system.

This embodiment of the present invention provides various report display formats to adapt to different needs of a user. This facilitates thorough analysis of corresponding service data.

In some embodiments, the data analysis system can analyze and process the multi-type service data report by using a PBC core algorithm to obtain a PBC report corresponding to the multi-type service data. Then, the data analysis system can determine, based on the PBC report, the N types of service data that fluctuate in the multi-type service data report.

In a specific implementation, the data analysis system can obtain a preset initial baseline. The initial baseline can include a first upper threshold, a first lower threshold, and a first average line. If determining that the multi-type service data report does not include Y types of service data that have M consecutive first data signals lower or greater than the first average line based on the initial baseline and the PBC report, the data analysis system can determine service data having a data signal lower than the first lower threshold or greater than the first upper threshold in the multi-type service data report as the N types of service data.

In a specific implementation, if determining that the multi-type service data report includes Y types of service data that have M consecutive first data signals lower or greater than the first average line based on the initial baseline and the PBC report, the data analysis system can adjust the initial baseline to a first baseline at the M first data signals. The first baseline can include a second upper threshold, a second lower threshold, and a second average line.

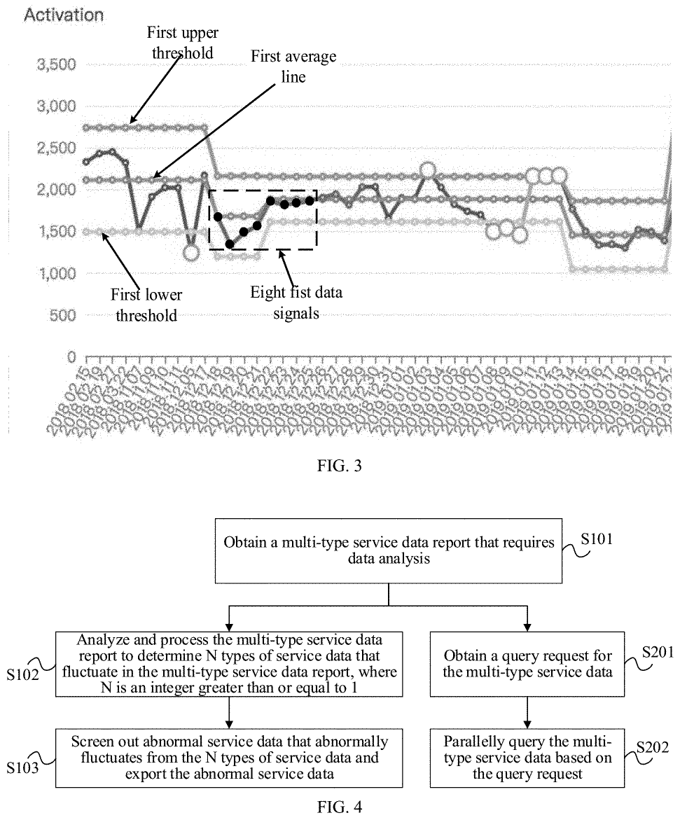

For example, M equals 8, as shown in FIG. 3. If determining that the multi-type service data report includes Y types of service data that have eight consecutive first data signals lower or greater than the first average line, the data analysis system can adjust the initial baseline to the first baseline for the eight first data signals. It can be understood that the initial baseline for the eight first data signals is adjusted to the first baseline.

In a specific implementation, if determining that X types of service data in the Y types of service data have M consecutive second data signals lower or greater than the second average line, the data analysis system adjusts the first baseline to a second baseline at the M second data signals, where the second baseline includes a third upper threshold, a third lower threshold, and a third average line. Then, the data analysis system can replace the initial baseline with the first baseline, the first baseline with the second baseline, and the Y types of service data with the X types of service data, and repeat the following step: if determining that Y types of service data in the multi-type service data report have M consecutive first data signals lower or greater than the first average line based on the initial baseline and the PBC report, adjust the initial baseline to the first baseline at the M first data signals. It can be understood that the data analysis system constantly adjusts the baseline for the PBC report until the multi-type service data report no longer includes service data having M consecutive data signals lower or greater than the average line of an adjusted baseline.

In a specific implementation, if determining that the Y types of service data does not include the X types of service data, the data analysis system can determine the Y types of service data as the N types of service data.

This embodiment of the present invention uses a PBC report to manage and analyze data. This can screen out a fluctuation noise in the analysis indicator, better reflect a fluctuation in the analysis indicator, and accurately identify a data signal (that is, service data). In addition, a baseline is adjusted if multiple consecutive data signals fluctuate. This reduces overreactions and helps reasonably measure service data. Therefore, data can be thoroughly analyzed.

S103: Screen out abnormal service data that abnormally fluctuates from the N types of service data and export the abnormal service data.

In some embodiments, if determining that the multi-type service data report does not include the Y types of service data, the data analysis system can determine service data greater than the first upper threshold or lower than the first lower threshold in the N types of service data as the abnormal service data.

In some other embodiments, if determining that the Y types of service data does not include the X types of service data, the data analysis system can determine service data greater than the second upper threshold or lower than the second lower threshold in the Y types of service data as the abnormal service data.

Instead of simply regarding fluctuant service data as abnormal service data, this embodiment of the present invention uses a PBC report to manage and analyze data and determines the service data that abnormally fluctuates in the fluctuant service data as abnormal service data. This reduces overreactions and helps reasonably measure service data. Therefore, service data can be thoroughly analyzed.

In some embodiments, after obtaining the abnormal service data, the data analysis system can export the abnormal service data visually (such as by using a color label or a statistical table). This helps a user visually identify abnormal service data and take corresponding measures.

To sum up, instead of simply regarding fluctuant service data as abnormal service data, the technical solutions provided in the embodiments of the present invention determine abnormal service data based on the N types of fluctuant service data in the multi-type service data report. This reduces overreactions and helps reasonably measure service data. Therefore, service data can be thoroughly analyzed.

With reference to FIG. 1 to FIG. 4, in an applicable scenario, the method for big data analysis provided in the embodiments of the present invention further includes the following steps:

S201: Obtain a query request for the multi-type service data.

In some embodiments, the data analysis system can provide an interface for querying multi-type service data, where the interface can provide controls for querying multi-type service data. This helps a user to query corresponding service data as needed. The user can select a control or select multiple controls at a time to query multiple types of service data. After the user submits the selection, a query request is generated and can be obtained by the data analysis system.

S202: Parallelly query the multi-type service data based on the query request.

In some embodiments, the data analysis system can parallelly query the multi-type service data based on the query request. In a specific implementation, the number of types of service data that the data analysis system can query once can be set.

Compared with the query of multi-type service data in a serial mode in the prior art, this embodiment of the present invention allows parallel query of multi-type service data. This improves data query efficiency and data query performance. In addition, the multi-type service data report includes information such as an analysis type dimension, analysis type, and analysis indicator. After a data analysis system queries the multi-type service data, the information corresponding to the multi-type service data can be reflected in the query result.

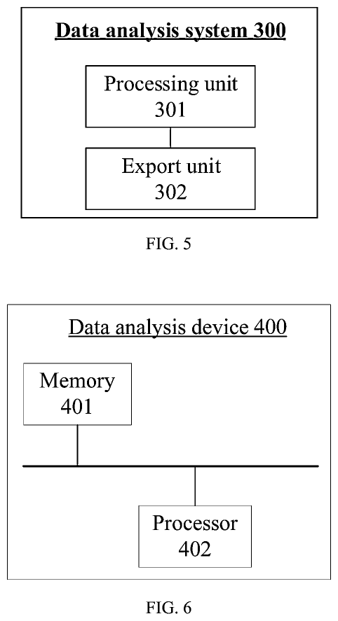

Based on the same inventive concept, an embodiment of the present invention provides a data analysis system, as shown in FIG. 5. The data analysis system 300 includes a processing unit 301 and an export unit 302.

The processing unit 301 is configured to: obtain a multi-type service data report that requires data analysis, and analyze and process the multi-type service data report to determine N types of service data that fluctuate in the multi-type service data report, where N is an integer greater than or equal to 1.

The export unit 302 is configured to: screen out abnormal service data that abnormally fluctuates from the N types of service data and export the abnormal service data.

In a possible design, the processing unit 301 is specifically configured to:

collect multi-type service data to obtain multi-type service datasets;

obtain a preset analysis type and a preset analysis indicator corresponding to the preset analysis type; and

perform statistical analysis on the multi-type service datasets based on the preset analysis type and the preset analysis indicator to obtain the multi-type service data report.

In a possible design, the processing unit 301 is specifically configured to:

obtain a preset analysis type dimension; and

collect the multi-type service data based on the analysis type dimension to obtain the multi-type service datasets.

In a possible design, if the preset analysis type is the number of DAUs, the preset analysis indicator includes one or more of an advertisement channel, country, and registration date. Alternatively, if the preset analysis type is player behavior, the preset analysis indicator includes one or more of player construction behavior, player production behavior, and alliance helping behavior.

In a possible design, the processing unit 301 is specifically configured to:

analyze and process the multi-type service data report by using a PBC core algorithm to obtain a PBC report corresponding to the multi-type service data; and

determine, based on the PBC report, the N types of service data that fluctuate in the multi-type service data report.

In a possible design, the processing unit 301 is specifically configured to:

obtain a preset initial baseline, where the initial baseline includes a first upper threshold, a first lower threshold, and a first average line; and

if it is determined, based on the initial baseline and the PBC report, that Y types of service data having M consecutive first data signals lower or greater than the first average line exist in the multi-type service data report, adjust the initial baseline to a first baseline at the M first data signals, where the first baseline includes a second upper threshold, a second lower threshold, and a second average line;

if it is determined that X types of service data having M consecutive second data signals lower or greater than the second average line exist in the Y types of service data, adjust the first baseline to a second baseline at the M second data signals, where the second baseline includes a third upper threshold, a third lower threshold, and a third average line; replace the initial baseline with the first baseline, the first baseline with the second baseline, and the Y types of service data with the X types of service data, and repeat the following step: if it is determined, based on the initial baseline and the PBC report, that Y types of service data having M consecutive first data signals lower or greater than the first average line exist in the multi-type service data report, adjust the initial baseline to the first baseline at the M first data signals; or

if it is determined that the X types of service data do not exist in the Y types of service data, determine the Y types of service data as the N types of service data.

In a possible design, the processing unit 301 is further configured to:

if it is determined, based on the initial baseline and the PBC report, that the Y types of service data do not exist in the multi-type service data report, determine service data having a data signal lower than the first lower threshold or greater than the first upper threshold in the multi-type service data report as the N types of service data.

In a possible design, the export unit 302 is specifically configured to:

if it is determined that the Y types of service data do not exist in the multi-type service data report, determine service data greater than the first upper threshold or lower than the first lower threshold in the N types of service data as the abnormal service data; or if it is determined that the X types of service data do not exist in the Y types of service data, determine service data greater than the second upper threshold or lower than the second lower threshold in the Y types of service data as the abnormal service data; and

visually export the abnormal service data.

In a possible design, the processing unit 301 is further configured to:

obtain a query request for the multi-type service data; and

parallelly query the multi-type service data based on the query request.

It should be noted that the processing unit 301 and the export unit 302 can be integrated into the same device or separately provided on different devices, which is not limited in the embodiments of the present invention.

The data analysis system 300 and the method for big data analysis shown in FIG. 1 and FIG. 4 use the same inventive concept in the embodiments of the present invention. A person skilled in the art can clearly understand the implementation of the data analysis system 300 in this embodiment based on the preceding detailed description of the method for big data analysis. For brevity, details are not repeated.

Based on the same inventive concept, an embodiment of the present invention further provides a data analysis device, as shown in FIG. 6. The data analysis device 400 includes at least one memory 401 and at least one processor 402.

The at least one memory 401 is configured to store one or more programs.

When the one or more programs are executed by the at least one processor 402, the method for big data analysis shown in FIG. 1 and FIG. 4 is implemented.

Optionally, the data analysis device 400 may further include a communications interface that is used for communication and data transmission with an external device.

It should be noted that the memory 401 may include a random access memory (RAM), or may further include a nonvolatile memory (nonvolatile memory), for example, at least one magnetic disk memory.

In specific implementation, if the memory 401, processor 402, and communications interface are integrated on a chip, the memory 401, processor 402, and communications interface can communicate with each other by using an internal interface. If the memory 401, processor 402, and communications interface are separate, the memory 401, processor 402, and communications interface can communicate with each other by using a bus.

Based on the same inventive concept, an embodiment of the present invention further provides a computer readable storage medium that can store at least one program. When the at least one program is executed by the processor, the method for big data analysis shown in FIG. 1 and FIG. 4 is implemented.

It should be understood that the computer readable storage medium is a data storage device that can store data or a program, where the data or program can be read by a computer system subsequently. For example, the computer readable storage medium may be a read-only memory (ROM), a random access memory (RAM), a compact disc read-only memory (CD-ROM), a hard disk drive (HDD), a digital video disk (DVD), a magnetic tape, an optical data storage device, or the like.

The computer readable storage medium may further reside in a computer system that is coupled with a network so that computer readable code can be stored and run in a distributed manner.

Program code in the computer readable storage medium can be transmitted by using any suitable medium, including but not limited to: wireless, wire, optical fiber, radio frequency (RF), or any suitable combination thereof.

The above-mentioned embodiments express only several implementations of the present invention, and the descriptions thereof are relatively specific and detailed, but they should not be thereby interpreted as limiting the scope of the present invention. It should be noted that those of ordinary skill in the art can further make several variations and improvements without departing from the idea of the present invention, but such variations and improvements shall all fall within the protection scope of the present invention.

What is claimed is:

1. A method for big data analysis, comprising:
obtaining a multi-type service data report that requires data analysis;
analyzing and processing the multi-type service data report to determine N types of service data that fluctuate in the multi-type service data report, wherein N is an integer greater than or equal to 1; and
screening out abnormal service data that abnormally fluctuates from the N types of service data and exporting the abnormal service data.

2. The method according to claim 1, wherein the step of obtaining the multi-type service data report that requires the data analysis comprises:
collecting multi-type service data to obtain multi-type service datasets;
obtaining a preset analysis type and a preset analysis indicator corresponding to the preset analysis type; and
performing statistical analysis on the multi-type service datasets based on the preset analysis type and the preset analysis indicator to obtain the multi-type service data report.

3. The method according to claim 2, wherein the step of collecting the multi-type service data to obtain the multi-type service datasets comprises:
obtaining a preset analysis type dimension; and
collecting the multi-type service data based on the preset analysis type dimension to obtain the multi-type service datasets.

4. The method according to claim 1, wherein the step of analyzing and processing the multi-type service data report to determine the N types of service data that fluctuate in the multi-type service data report comprises:
analyzing and processing the multi-type service data report by using a process behavior chart (PBC) core algorithm to obtain a PBC report corresponding to the multi-type service data; and
determining, based on the PBC report, the N types of service data that fluctuate in the multi-type service data report.

5. The method according to claim 4, wherein the step of determining, based on the PBC report, the N types of service data that fluctuate in the multi-type service data report comprises:
obtaining a preset initial baseline, wherein the preset initial baseline comprises a first upper threshold, a first lower threshold, and a first average line; and
when it is determined, based on the preset initial baseline and the PBC report, that Y types of service data having M consecutive first data signals lower or greater than the first average line exist in the multi-type service data report, adjusting the preset initial baseline to a first baseline at the M consecutive first data signals, wherein the first baseline comprises a second upper threshold, a second lower threshold, and a second average line; when it is determined that X types of service data having M consecutive second data signals lower or greater than the second average line exist in the Y types of service data, adjusting the first baseline to a second baseline at the M consecutive second data signals, wherein the second baseline comprises a third upper threshold, a third lower threshold, and a third average line; replacing the preset initial baseline with the first baseline, the first baseline with the second baseline, and the Y types of service data with the X types of service data, and repeating the following step: when it is determined, based on the preset initial baseline and the PBC report, that Y types of service data having M consecutive first data signals lower or greater than the first average line exist in the multi-type service data report, adjusting the preset initial baseline to the first baseline at the M consecutive first data signals; or when it is determined that the X types of service data do not exist in the Y types of service data, determining the Y types of service data as the N types of service data; or
when it is determined, based on the preset initial baseline and the PBC report, that the Y types of service data do not exist in the multi-type service data report, determining service data having a data signal lower than the first lower threshold or greater than the first upper threshold in the multi-type service data report as the N types of service data.

6. The method according to claim 5, wherein the step of screening out the abnormal service data that abnormally fluctuates from the N types of service data and exporting the abnormal service data comprises:
when it is determined that the Y types of service data do not exist in the multi-type service data report, determining service data greater than the first upper threshold or lower than the first lower threshold in the N types of service data as the abnormal service data; or when it is determined that the X types of service data do not exist in the Y types of service data, determining service data greater than the second upper threshold or lower than the second lower threshold in the Y types of service data as the abnormal service data; and
visually exporting the abnormal service data.

7. The method according to claim 1, after the step of obtaining the multi-type service data report that requires the data analysis, further comprising:
obtaining a query request for the multi-type service data; and
parallelly querying the multi-type service data based on the query request.

8. A system for big data analysis, comprising:
a processing unit, configured to: obtain a multi-type service data report that requires data analysis, and analyze and process the multi-type service data report to determine N types of service data that fluctuate in the multi-type service data report, wherein N is an integer greater than or equal to 1; and
an export unit, configured to: screen out abnormal service data that abnormally fluctuates from the N types of service data and export the abnormal service data.

9. The method according to claim 2, wherein the step of analyzing and processing the multi-type service data report to determine the N types of service data that fluctuate in the multi-type service data report comprises:
analyzing and processing the multi-type service data report by using a PBC core algorithm to obtain a PBC report corresponding to the multi-type service data; and
determining, based on the PBC report, the N types of service data that fluctuate in the multi-type service data report.

10. The method according to claim 3, wherein the step of analyzing and processing the multi-type service data report to determine the N types of service data that fluctuate in the multi-type service data report comprises:
analyzing and processing the multi-type service data report by using a PBC core algorithm to obtain a PBC report corresponding to the multi-type service data; and
determining, based on the PBC report, the N types of service data that fluctuate in the multi-type service data report.

11. The method according to claim 2, after the step of obtaining the multi-type service data report that requires the data analysis, further comprising:
obtaining a query request for the multi-type service data; and
parallelly querying the multi-type service data based on the query request.

12. The method according to claim 3, after the step of obtaining the multi-type service data report that requires the data analysis, further comprising:
obtaining a query request for the multi-type service data; and
parallelly querying the multi-type service data based on the query request.

13. The method according to claim 4, after the step of obtaining the multi-type service data report that requires the data analysis, further comprising:
obtaining a query request for the multi-type service data; and
parallelly querying the multi-type service data based on the query request.

14. The method according to claim 5, after the step of obtaining the multi-type service data report that requires the data analysis, further comprising:
obtaining a query request for the multi-type service data; and
parallelly querying the multi-type service data based on the query request.

15. The method according to claim 6, after the step of obtaining the multi-type service data report that requires the data analysis, further comprising:
obtaining a query request for the multi-type service data; and
parallelly querying the multi-type service data based on the query request.
